(19) United States
(12) Patent Application Publication
(10) Pub. No.: US 2002/0087497 A1
(43) Pub. Date: Jul. 4, 2002

(54) Creation of tree-based and customized industry-oriented knowledge base

(76) Inventors: Galina Troianova, Minsk (BY); Alexander Kirkovsky, Melrose, MA (US); Maxim Rastapchuk, Minsk (BY); Igor Sovpel, Minsk (BY)

Correspondence Address: STANGER & DREYFUS, 608 SHERWOOD PKWY, MOUNTAINSIDE, NJ, 07092, US

(21) Appl. No.: 09/841,697

(22) Filed: Apr. 24, 2001

Related U.S. Application Data
(63) Continuation-in-part of application No. 09/541,182, filed on Apr. 3, 2000.
(63) Continuation-in-part of application No. 09/321,804, filed on May 27, 1999.
(60) Provisional application No. 60/199,658, filed on Apr. 25, 2000.
(60) Provisional application No. 60/199,921, filed on Apr. 26, 2000.

(51) Int. Cl. G06F 17/00

(52) U.S. Cl. 706/45

(57) ABSTRACT

A customized industry-oriented knowledge base (CIO KB) with information which is relevant to a user's interests includes information about different relevant natural/technical items or processes relating to given industry or discipline. This involves forming a customized industry-oriented knowledge base (CIO KB) on the basis of tree of the CIO KB comprising names of items, processes, parameters which relevant to given industry. The CIO KB is formed from an SAO KB (subject-action-object knowledge base) by selection of all the SAOs comprising the mentioned names of relevant items, processes, or parameters in their subjects or objects.

### RELATED APPLICATIONS

This application is a continuation-in-part of U.S. patent applications Ser. Nos. 60/199,658 filed Apr. 25, 2000 and 60/199,921 filed Apr. 26, 2000, and is related to copending U.S. patent application Ser. No. 09/541,192 filed Apr. 3, 2000, which is a continuation application of copending U.S. patent application Ser. No. 09/345,547, filed Jun. 30,1999 which is a continuation-in-part of copending U.S. patent application Ser. No. 09/321,804 filed May 27, 1999, and is also related to the copending provisional application of Galina Troyanova entitled Synonym Extension Of Search Queries With Validation being filed concurrently herewith. These applications are herewith incorporated herein by reference.

### FIELD OF THE INVENTION

This invention relates to computer based knowledge bases, and particularly to creation of specialized knowledge bases from various natural language texts.

### BACKGROUND OF THE INVENTION

Computer based document search processors are known to perform key word searches for publications on the World Wide Web and other sources of information. Today a user can download 10,000 papers from the Web by typing the word “Screen”. These can include computer screen, TV Screen, window screen, and other screens. Because of the enormous amount of information available on the Web, key word search processors produce too much downloaded information, the vast majority of which is irrelevant or immaterial to the information the user wants.

Various attempts purport to increase the recall and precision of the selection such as U.S. Pat. Nos. 5,774,833 and 5,794,050 incorporated here by reference, however, these methods simply rely on key word or phrase searching. U.S. Pat. No. 6,167,370 discloses means to semantically process candidate documents for specific technological functions and specific physical effects so that fewer prioritized articles meeting the search criteria are presented or identified to the user. The application proposes Subject-Action-Object extractions within each sentence and stores them.

A Subject-Action-Object Knowledge Base (SAO KB) contains the fields with subjects, actions, and objects and is prepared from natural language texts with help of a semantic processor. These are described in copending U.S. patent application Ser. No. 09/541,192 filed Apr. 3, 2000. However, the size of an SAO KB, when it exceeds 100 million SAOs may make it cumbersome to obtain specialized information in a limited field.

An object of the invention is to improve search systems of this type and to produce a customized industry-oriented knowledge base (CIO KB).

### SUMMARY OF EMBODIMENTS OF THE INVENTION

An embodiment of the invention involves an industry-oriented knowledge base tree submitting a computer search query and extracting documents from a document source on the basis of the query; semantically processing language from extracted documents in a semantic processor to obtain subject-action-object groups (SAOs); selecting relevant results from the SAOs and entering the relevant results back into the knowledge base tree; successively submitting new queries from the knowledge base tree so as to extract additional documents from the document source and semantically processing SAOs from extracted documents and in a loop successively reentering relevant results obtained from the SAOs back into the knowledge base tree; and extracting information from the knowledge base tree and the SAOs to produce a customized industry oriented knowledge base (CIO KB).

These and other aspects, objects, and advantages of the invention will become evident from the following description of exemplary embodiments when read in light of the accompanying drawings.

### BRIEF DESCRIPTION OF THE DRAWINGS

FIG. 1 is a block diagram of a computer system containing a computer program embodying this invention.

FIG. 2, is a flow chart illustrating operation of the computer program in FIG. 1.

FIG. 3 is a flow chart showing further details of the computer program of FIG. 2.

FIGS. 4a, 4b, and 4c are examples of screens appearing in the monitor of the computer of FIG. 1 and data from the program of FIGS. 2 and 3.

### DETAILED DESCRIPTION OF PREFERRED EMBODIMENTS

The following are incorporated herein by reference:

I. The system and on-line information service presently available at www.cobrain.com and the publicly available user manual therefor.

II. The software product presently marketed by Invention Machine Corporation of Boston, Mass., USA, under it's trademark “KNOWLEDGIST” and the publicly available user manual therefor.

III. U.S. Pat. No. 6,167,370.

IV. U.S. patent application Ser. No. 09/541,182 filed Apr. 3, 2000.

V. The software product presently marketed by Invention Machine Corporation of Boston, Mass., USA under its Trademark “TECHOPTIMIZER” and the publicly available user manual therefor.

VI. U.S. Pat. No. 5,901,068.

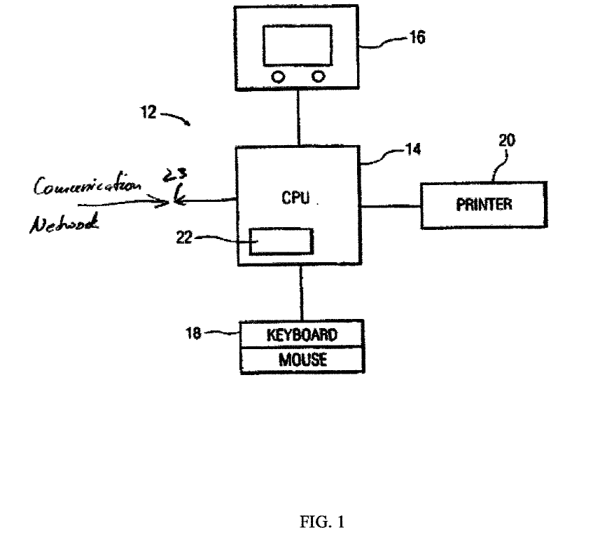

In FIG. 1, a tool or program for creating a tree-based and industry-oriented knowledge base embodying the invention resides in a personal computer 12 and that includes a CPU 14, a monitor 16, a keyboard/mouse 18, and a printer 20. The program may be stored on a portable disk and inserted in a disk reader slot 22 or on a fixed disc in the computer or on a ROM. According to an alternate embodiment the program resides on a server and the user accesses the program via the communication ports 23, a LAN (local area network), WAN (wide area network), or the Internet. Computer 12 can be conventional and be of any suitable make or brand. Other peripherals and modem/network interfaces can be provided as desired. For convenience the program utilizes the displays in the system and on-line information service presently available at www.cobrain.com.

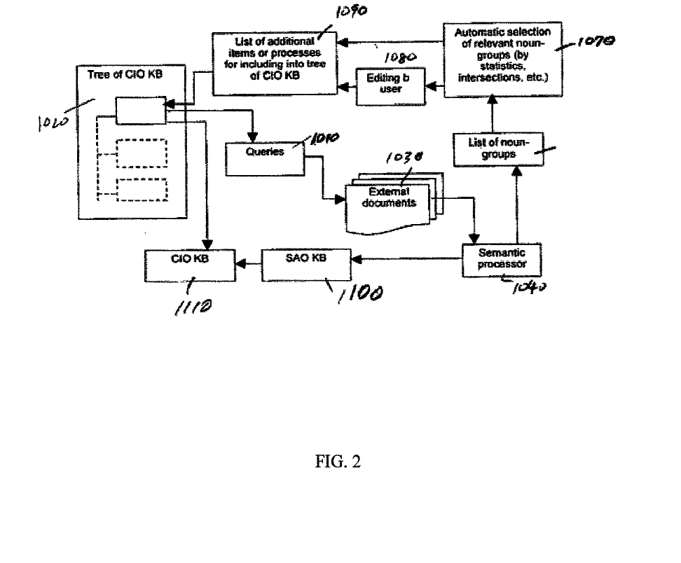

FIG. 2 is a flow chart that illustrates a tool embodying the invention. To start a user is invited to create or enter a knowledge base tree. It may be entered in an ordinary word-processing program or a database program and imported into the program of FIG. 2. This knowledge base is hereafter referred to the tree of the CIO KB.

According to an embodiment, the tree of the CIO KB is in the form of a single word, but according to another embodiment, is a multilevel hierarchical list of items and/or processes (technical, natural, or other) and/or its parameters with synonyms related to a given industry or discipline. According to an embodiment, pre-formulated industry trees are stored in a dictionary that enables a user to search for a selected tree and enter a desired tree. In addition, the user can enter a manual mode and enter terms to generate a tree of the user's own interest.

The tree includes the names of the tree's branches and expressions for a search, in object/subject form, of an SAO KB. If the SAO contains these expressions in their subject or object, this SAO is included into given tree's branch. A user can choose the classification type—for subjects, or for objects. The object classification follows:

A multilevel CIO KB tree has the following form:

| | | | Synonymous or |
|---|---|---|---|
| | | | near-synonymous |
| | | | expressions for |
| | | | last level of tree |
| | | | (used for search |
| | Intermediate level | Last | in object/subject |
| First level of tree | of tree | level of tree | in SAO KB) |
| Microelectronics | | | |
| | Lithography | | |
| | | Resist | |
| | | | Resist |
| | | | Photoresist layer |
| | | Wafer | |
| | | | Wafer |
| | | | Substrate |

The general scheme of the tool appears in FIG. 2. It includes the following stages performed by the computer 12. These are:

1. Preparing an initial list of queries 1010 from the names of items or processes, or their parameters extracted from a given branch or branches of the tree of the CIO KB 1020. There are several ways to prepare list of queries. In a first embodiment the way is to form queries from expressions of the last level of the tree connected by the Boolean Expression “OR”; for example:

[Resists] OR [Photoresist layer];

[Wafer] OR [Substrate].

According to another, more complicated but more accurate system, way is to form queries from expressions at the last level of the tree joined by “OR” and name of a higher level connected by an “AND”.

For example:

[Lithography] AND {[Resists] OR [Photoresist layer]};

[Lithography] AND {[Wafer] OR [Substrate]}.

If the tree of the CIO KB is initially empty, the user may prepare an initial query.

2. Searching for documents related to these queries in external information sources at 1030 (WWW, Intranet, or other external documents),

3. A Semantic Processor at 1040 treats the found documents. For this purpose, it extracts all subject-action-object (SAO) relations from the documents at 1050 and extracts noun groups from the documents at 1060 (according to U.S. patent application Ser. No. 09/541,182 filed Apr. 3, 2000). Usually, noun groups represent the names of items/processes, or parameters.

4. Automatic selection at 1070 of noun groups (items/processes, or parameters) relevant to a found document.

According to an embodiment the following algorithm is used to calculate relevance of noun groups extracted from document.

A. Extract all significant words (nouns and adjectives) from noun group by tags.

B. Calculate the estimating value (weight) of each significant word of noun group is calculated. To calculate the estimating value the algorithm takes into account:

The word frequency in the document;

This word is either subject or object;

The word is take part in some semantic relation of SAO. In other words it is included in the main word in the noun group;

The word is part of the title.

C. Calculate the final estimating value of A noun group as the arithmetic mean of estimating values of all its constituent significant words.

The higher obtained estimating value indicates the more relevant noun group to the source document.

In addition to selection of relevant noun groups, filtration, according to an embodiment is accomplished with help of a stop- that include too general expressions.

At unit 1080, the user can remove, edit and (or) classify noun groups.

5. A list of selected items/processes, or parameters is added at 1090 to the same branch of the tree of the CIO KB where initial list of queries was extracted. This renews and extends the tree 1020 of the CIO KB. The extended tree 1020 serves for producing the next generation of queries. According to an embodiment, this procedure is performed in a loop.

6. SAOs extracted by the semantic processor 1040 from external documents 1030 form a new SAO KB at 1100 or are merged into an existing SAO KB. The tree 1020 is used to create the CIO KB at 1110 from SAO KB at 1100.

At first, the search is performed of SAOs whose objects contain the expressions of last-level of the tree. Then, found SAOs, their original sentences and references are joined with given branch of tree. Hierarchically organized SAOs, their original sentences and references constitute the CIO KB.

Extension of the tree 1020 causes extension of the created CIO KB.

Thus the user can prepare his/her own (customized) tree and the CIO KB. Moreover, the tool of this embodiment employs positive feedback—since, extended tree generates extended queries, and as consequence—more volume of relevant text information enters the CIO KB at 1110. This is called a “self-learning system”.

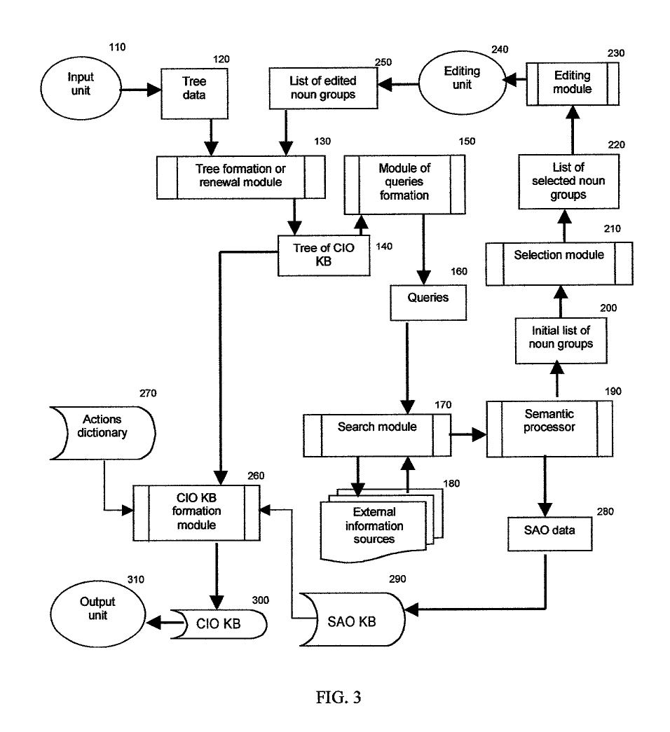

A more detailed embodiment of a tool appears in FIG. 3. Here an input unit 110 receives initial tree data 120 from a user or automatically. It is possible to begin from an initial tree having only one word or expression. Initial tree data can be represent in any text format. Tree data 120 are transmitted into tree formation or renewal module 130, which forms the tree 140 of the CIO KB.

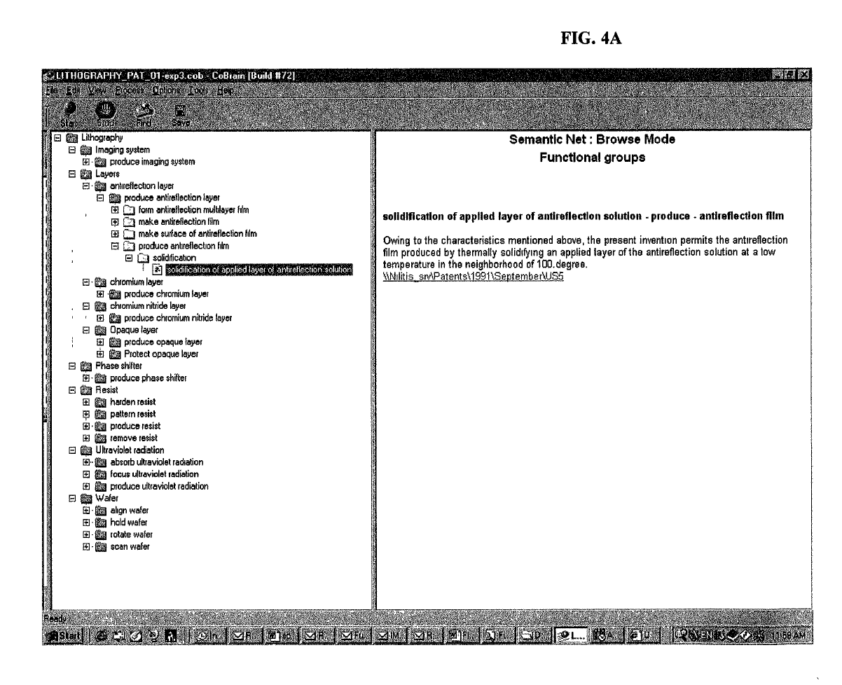

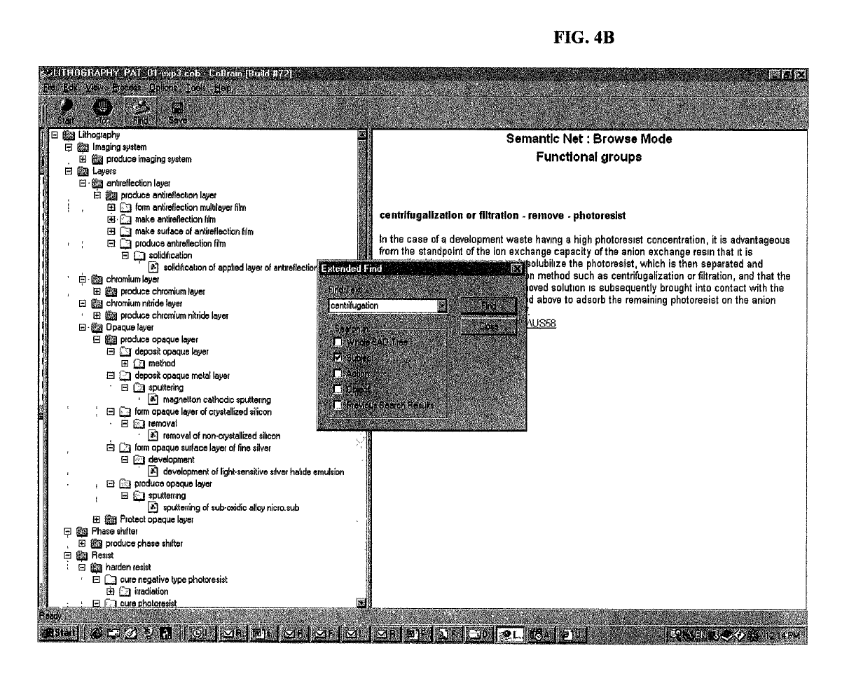

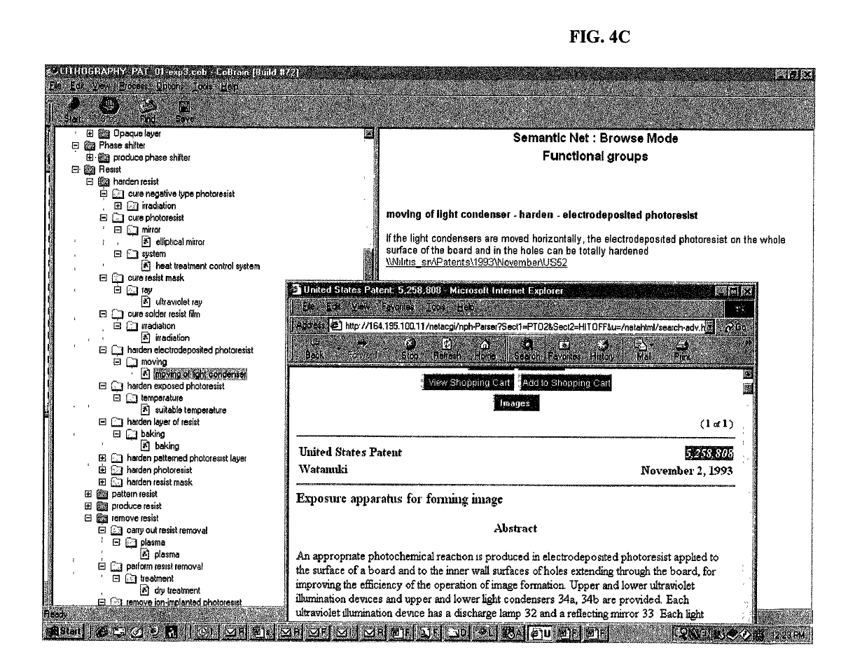

The content from the tree 140 (either all expressions at the last levels of the tree or only expressions that were selected by user) is transmitted into a queries formation module 150, which forms a query or a set of queries 160. In addition, content of the tree 140 passes into a CIO KB formation module 260 for formation of a CIO KB 300, which is made available for display by the user by an output unit 310. The display appears in FIG. 4.

Queries 160 pass into a search module 170. The search module 170 uses the queries 160 to search documents from different external information sources 180. The search module 170 downloads the found relevant documents and transmits them to a semantic processor 190.

The semantic processor 190 extracts noun groups 200 from the natural language text documents. The semantic processor 190 also converts natural language texts into Subject-Action-Object (SAO) relations. This SAO data 280 is stored in an SAO Knowledge Database (SAO KB) 290.

For example, semantic processor 190 can extract the following noun groups: “Thin photoresist layer” and “UV laser light” from the sentence: “Thin photoresist layer is heated by UV laser light” and convert it into following fields in the SAO KB:

Subject—”UV laser light”;

Action—“heat”;

Object—”Thin photoresist layer”.

The initial list of noun groups 200 extracted by semantic processor 190 is transmitted into selection module 210. Selection module 210 removes non-informative noun groups and performs the selection of relevant noun groups. Removal of non-informative noun groups is performed with help of a stop-dictionary, that includes too general expressions, such as “method”, “device”, “advanced technology”, etc.

To select relevant noun groups, their estimation are performed accordingly the following rules:

A. All significant words (nouns and adjectives) are extracted from noun group by tags.

B. Estimating value (weight) of each significant word of noun group is calculated. The estimation algorithm takes into account:

word frequency in the document;

word position in subject or object;

presence of given word in title, etc.

C. Final estimation of the noun group is calculated as the arithmetic mean of estimating values of all its constituent significant words.

The most relevant noun group to source document has the highest estimating value.

A list of selected noun groups 220 advances into an editing module 230 and the user can remove, edit, and/or classify the selected noun groups in editing unit 240. A list of these edited noun groups 250 passes into the tree formation or renewal module 130 and serves for expansion of the tree 140.

The data in tree 140 of the CIO KB passes into a CIO KB formation module 260. This module forms the CIO KB 300 with help of the tree 140 and SAO KB 290. The CIO KB includes the SAOs with objects containing the expressions from the tree 140 of the CIO KB.

To form the CIO KB, a search is performed of SAOs whose objects contain the expressions of last level of the tree. Then found SAOs, their original sentences and references join with the given branch of tree.

All the SAOs are grouped by folders according to tree branches. SAOs inside the every folder can be placed alphabetically or grouped by subfolders with the help of an action dictionary 270.

Subfolders are formed on the basis of actions in the dictionary 270. The latter contains six parts, namely a:

List of verbs divided in groups, containing the verbs with similar sense (heat-warm, produce-create-generate, etc.);

List of “verb-noun” expressions synonymous with other verbs (heat—increase temperature—rise temperature, etc.)

List of “verbsA” including the verbs—perform, carry out, realize, and other verbs with similar sense;

List of “noun” including the following groups—“verb—relevant verbal noun” (heat—heating; produce—production, etc.)

List of “verbsB” including the verbs—produce, create, form, and other verbs with similar sense;

List of “participle2” including the following groups—“verb—relevant participle2” (heat—heated; produce—produced, etc.).

The use of action dictionary 270 allows collection of SAOs with similar actions. For example, the program can collect SAOs with the following AO: “heat—something, increase—temperature of something, perform—heating of something, and produce heated something” into single subfolder with name: “heat—something”.

The proposed tool may for example operate as follows:

At the beginning we have some data 120 for the tree 140 (it is possible to begin from one word or expression):

| | | Synonymous or near- |
|---|---|---|
| | | synonymous expressions for |
| | | last level of tree (used for |
| | | search in object/subject in |
| First level of tree | Last level of tree | SAO KB) |
| Lithography | Imaging system | |
| | | Imaging optics |
| | | Imaging system |
| | Phase shifter | |
| | | Phase shifter |
| | | Phase shifting mask |
| | | Phase shift region |
| | | Phase shifter material |
| | Resist | |
| | | Photoresist |
| | | Resist mask |
| | | Layer of photoresist |
| | | Layer of resist |
| | | Photoresist layer |
| | | Resist film |
| | | Resist |

Tree formation or renewal module 130 forms the tree 140. This tree 140 is the source for forming the query 160 with module 150. The query can have different configurations depending on the user' choice.

For example, it is possible to form the following queries from above-mentioned tree:

[Imaging system] OR [Optical imaging system] OR [Imaging optics];

[Phase shifter] OR [Phase shifting mask] OR [Phase shift region] OR [Phase shifter material];

[Resist] OR [Photoresist] OR [Resist mask] OR [Layer of photoresist]OR [Layer of resist] OR [Photoresist layer] OR [Resist film];

or

[Lithography] AND {[Imaging system] OR [Optical imaging system] OR [Imaging optics]}

[Lithography] AND {[Phase shifter] OR [Phase shifting mask] OR [Phase shift region] OR [Phase shifter material]}

[Lithography] AND {[Resist] OR [Photoresist] OR [Resist mask] OR [Layer of photoresist] OR [Layer of resist] OR [Photoresist layer] OR [Resist film]}.

The search module 170 performs a search of documents according to the queries 160. The semantic processor 190 treats the found documents. This results in SAOs 280 that are transmitted into an SAO KB 290. Besides SAOs, the semantic processor 190 forms the list of noun groups 200, which are absent from the initial queries. Selection module 210 filters these nouns groups to remove non-informative data. According to an embodiment, filtration is accomplished with help of a stop-dictionary and (or) selection of most relevant noun groups. Then the user can remove, edit, and classify these noun groups with help of editing module 230. This produces the list of edited and classified noun groups 250 which are added into initial tree of the CIO KB 300 by tree formation or renewal module 130:

| | | Synonymous or near- |
|---|---|---|
| | | synonymous expressions for |
| | | last level of tree (used |
| | | for search in object/subject |
| First level of tree | Last level of tree | in SAO KB) |
| Lithography | Ultraviolet radiation | |
| | | Far-ultra violet light |
| | | UV laser light |
| | | Ultraviolet radiation |
| | | UV light |
| | | UV radiation |
| | Wafer | |
| | | Wafer |
| | | Substrate |
| | | Wafer disk |
| | Opaque layer | |
| | | Opaque layer |
| | | Opaque pattern layer |
| | | Opaque metal layer |
| | | Opaque surface layer |
| | Antireflection layer | |
| | | Antireflection layer |
| | | Antireflection multilayer film |
| | | Antireflection film |
| | | Surface of antireflection film |

Thus, the initial tree (which contained three branches—Imaging system, Phase shifter, Resist) is converted into a more complicated tree with additional branches (Ultraviolet radiation, Wafer, Opaque layer, Antireflection layer).

The module 260 forms the CIO KB 300 from the SAO KB 290 with help of the renewed tree 140 and actions dictionary 270. At first, the search is performed of SAOs whose objects contain the expressions of the last level of the tree. All the found SAOs, their original sentences and references are grouped by folders according to tree branches. For example, tree branch “Ultraviolet radiation” collects the following SAOs, their original sentences and references:

Ultraviolet Radiation

convex lens—focus—ultraviolet radiation

The air filter includes a cabinet which houses an electrostatic air filter, an ultraviolet lamp and a parabolic reflector or a convex lens for focusing the ultraviolet radiation emitted by the lamp on an upstream side of the air filter.

\\Nilitis_srv\Patents\1998\November\US5837207

electron—molecule collision—generate—ultraviolet radiation

The electrons are maintained at this temperature for a sufficient time to enable the free electrons to dissociate the waste material as a result of collisions and ultraviolet radiation generated in situ by electron-molecule collisions.

\\Nilitis_srv\Patents\1994\February\US5288969

micro-lens array plate—focus—UV light

Second, in a LCD utilizing phosphor elements as light source, a micro-lens array plate can be used to focus the UV light onto the phosphor elements for reduction of power consumption by the lamps.

\\Nilitis_srv\Patents\1999\February\US5871653

objective lens—condense—UV laser light

The UV laser light is then reflected by the mirror 14 and condensed by an objective lens 6 so as to be radiated on an optical disc 8.

\\Nilitis_srv\Patents\1998\October\US5822287

plasma—produce—intense ultraviolet radiation

An advantageous development is that the plasma that produces the intense ultraviolet radiation in the wavelength below 200 nm is excited in the laser.

\\Nilitis_srv\Patents\1993\September\US5244428

surface or corona discharge—produce—ultraviolet radiation

A miniature solid state laser is optically pumped by ultraviolet radiation produced by a surface or corona discharge.

\\Nilitis_srv\Patents\1999\June\US502387

Then SAOs inside the every folder are grouped by subfolders with help of the action dictionary 270:

Ultraviolet Radiation

Focus Ultraviolet Radiation

convex lens—focus—ultraviolet radiation

The air filter includes a cabinet which houses an electrostatic air filter, an ultraviolet lamp and a parabolic reflector or a convex lens for focusing the ultraviolet radiation emitted by the lamp on an upstream side of the air filter.

\\Nilitis_srv\Patents\1998\November\US5837207

micro-lens array plate—focus—UV light

Second, in a LCD utilizing phosphor elements as light source, a micro-lens array plate can be used to focus the UV light onto the phosphor elements for reduction of power consumption by the lamps.

\\Nilitis_srv\Patents\1999\February\US5871653

objective lens—condense—UV laser light

The UV laser light is then reflected by the mirror 14 and condensed by an objective lens 6 so as to be radiated on an optical disc 8.

\\Nilitis_srv\Patents\1998\October\US5822287

Produce Ultraviolet Radiation

electron-molecule collision—generate—ultraviolet radiation

The electrons are maintained at this temperature for a sufficient time to enable the free electrons to dissociate the waste material as a result of collisions and ultraviolet radiation generated in situ by electron-molecule collisions.

\\Nilitis_srv\Patents\1994\February\US5288969

plasma—produce—intense ultraviolet radiation

An advantageous development is that the plasma that produces the intense ultraviolet radiation in the wavelength below 200 nm is excited in the laser.

\\Nilitis_srv\Patents\1993\September\US5244428

surface or corona discharge—produce—ultraviolet radiation

A miniature solid state laser is optically pumped by ultraviolet radiation produced by a surface or corona discharge.

\\Nilitis_srv\Patents\1991\June\US502387

An illustration obtained for CIO KB 300 appears in FIG. 4a.

According to an embodiment the CIO KB is used for storage and fast search of information concerning various technical problems. A user can accomplish the search by browsing in tree or with help of “Extended Find” as shown on FIG. 4b. The information is present for the user in a few forms:

brief form—as SAO (for example, “moving of light condenser—harden—electrodeposited photoresist”)

more extended form—as original sentence (for example, “If the light condensers are moved horizontally, the electrodeposited photoresist on the whole surface of the board and in the holes can be totally hardened.”)

reference form—as reference (URL) on corresponding document (in our example—U.S. Pat. No. 5,258,808—see FIG. 4c.)

Thus, the user has possibility of both a fast review of information (in SAO form and original sentence), and careful study of a reference document.

It will be understood that various other display symbols, emblems, colors, and configurations can be used instead of those disclosed for the exemplary embodiments herein. Also, various improvements and modifications can be made to the herein disclosed exemplary embodiments without departing from the spirit and scope of the present invention. The system and method according to the inventive principles herein are necessarily not dependent upon the precise exemplary hardware or software architecture disclosed herein.

The term “stop-dictionary” is the common name for dictionaries, which remove from a list, or prohibit the display of words (or expressions) that appear in these dictionaries.

A user may use the CIO KB for categorization of knowledge (in both the form of SAO and noun groups), which is extracted from documents with the help of the semantic processor. A user may employ the CIO KB for categorization of documents because it contains references to documents from which SAO and noun groups are extracted. A user can define peculiarities of the categorization by forming an initial tree and editing the renewed tree.

A user can store the CIO KB as a repository for information relevant to the user's technology or interest and access the outside sources such as the Internet only for updates.

1. A method of forming a customized industry-oriented knowledge base (CIO KB) in a computer, comprising:
submitting a computer search query concerning an industry with a knowledge base tree, and with an extraction section extracting documents from a document source on the basis of the query;
semantically processing language from extracted documents in a semantic processor of the computer to obtain subject-action-object groups (SAOs);
selecting relevant results from the SAOs and entering the relevant results in the knowledge base tree;
successively submitting queries from the knowledge base tree so as to extract additional documents from the document source and semantically process SAOs from extracted documents and in a loop successively reentering relevant results obtained from the SAOs back into the knowledge base tree; and
extracting information from the knowledge base tree and the saos to produce a CIO KB.

2. A method as in claim 1, wherein the relevant results are noun groups selected from the SAOs.

3. A method as in claim 1, further comprising adding a list of actions from an actions dictionary to the.

4. A method as in claim 1, wherein the step of submitting queries includes submitting a list of queries from the names of items or processes, or their parameters extracted from a given branch or branches of the knowledge base tree.

5. A method as in claim 1, wherein the step of extracting the documents from an external source includes extracting the documents from the World Wide Web, or intranet.

6. A method as in claim 1, wherein the step of semantically processing language from the extracted documents includes extracting subject-action-object (SAO) relations and noun groups from the documents.

7. A method as in claim 6, wherein the noun groups represent the names of items, processes, or parameters.

8. A method as in claim 1, wherein selection of the relevant results includes selection by statistics, or intersections of relevant results concerning a given industry or discipline.

9. A method as in claim 8, wherein the relevant results are edited.

10. A method as in claim 6, wherein selection of the noun groups include selection by statistics, or intersections of noun groups concerning a given industry or discipline.

11. A method as in claim 7, wherein the noun groups are edited manually.

12. A method as in claim 1, wherein a query is submitted from a branch of the knowledge base tree and the relevant results is reentered into the same branch of the knowledge base tree.

13. A method as in claim 1, wherein the semantically processed data is formed into SAOs and merged into an SAO knowledge base (SAO KB).

14. A method as in claim 12, wherein said SAO KB and said knowledge base tree form said CIO KB.

15. A computer system for forming a customized industry-oriented knowledge base (CIO KB) in a computer, comprising:
a knowledge base tree
an extraction section for submitting a computer search query concerning an industry from the knowledge base tree and extracting documents from a document source on the basis of the query;
a processing section for semantically processing language from extracted documents to obtain subject-action-object groups (SAOs);
a selection section for selecting relevant results from the SAOs and entering the relevant results back into the knowledge base tree; and
a formation section for extracting information from the knowledge base tree and the SAOs to produce a CIO KB.

16. A system as in claim 14, wherein the relevant results are noun groups selected from the SAOs.

17. A system as in claim 14, wherein the formation section includes an actions dictionary.

18. A system as in claim 14, wherein the knowledge base tree submits queries including from the names of items or processes, or their parameters extracted from a given branch or branches of the knowledge base tree.

19. A system as in claim 14, wherein the extracting section extracts the documents from an external source including the World Wide Web, or intranet.

20. A system as in claim 14, wherein the processing section extracts subject-action-object (SAO) relations and noun groups from the documents.

21. A system as in claim 20, wherein the noun groups represent the names of items, processes, or parameters.

22. A system as in claim 14, wherein the selection section selects by statistics, or intersections of relevant results concerning a given industry or discipline.

23. A system as in claim 21, wherein the selection section includes an editing unit.

24. A system as in claim 19, wherein the selection section selects noun groups by statistics, or intersections of noun groups concerning a given industry or discipline.

25. A system as in claim 20, wherein selection section includes a manual editor.

26. A system as in claim 14, wherein said tree has branches and query is submitted from a branch of the knowledge base tree and the relevant results is reentered into the same branch of the knowledge base tree.

27. A system as in claim 14, wherein the processing section includes an SAO knowledge base (SAO KB) for storing the SAOs.

28. A system as in claim 27, wherein said SAO KB and said knowledge base tree form said CIO KB with an action dictionary.
